(19) United States
(12) Patent Application Publication
(10) Pub. No.: US 2001/0014404 A1
(43) Pub. Date: Aug. 16, 2001

(54) SUPERPLASTIC ALUMINUM ALLOY AND PROCESS OF PRODUCING SAME

(75) Inventors: YOSHIHARU MIYAKE, SHIZUOKA (JP); YOSHIHISA SERZAWA, SHIZUOKA (JP); YUKIO OKOCHI, TOYOTA-SHI (JP)

Correspondence Address: FINNEGAN HENDERSON FARABOW, GARRETT & DUNNER, 130 I STREET NW, WASHINGTON, DC, 20005

(73) Assignee: TOYOTA JIDOSHA KABUSHIKI KAISHA

(21) Appl. No.: 08/896,101

(22) Filed: Jul. 17, 1997

(30) Foreign Application Priority Data
Jul. 22, 1996 (JP) 8-209364

(51) Int. Cl. B32B 15/04; C22C 21/06

(52) U.S. Cl. 428/553; 148/564

(57) ABSTRACT

The present invention provides a superplastic aluminum alloy in which fine particles not substantially dispersion hardening are dispersed in a sufficient amount to effect grain boundary pinning to suppress crystal grain growth during hot working thereby ensuring manifestation of superplasticity over wide ranges of working temperature and strain rate.

According to the present invention, a superplastic aluminum alloy contains ceramic particles having an average particle size of from 10 nm to 500 nm in an amount of from 0.1 vol % to 5 vol % and a process of producing a superplastic aluminum alloy, comprises the steps of: hot working an aluminum alloy ingot containing ceramic particles having an average particle size of from 10 nm to 500 nm in an amount of from 0.1 vol % to 5 vol % with a working degree of from 10% to 40% at a temperature of 400° C. or higher; heat-treating at a temperature of 400° C. or higher; and hot-working with a working degree of 40% or more at a temperature of lower than 400° C.

### BACKGROUND OF THE INVENTION

1. Field of the Invention

The present invention relates to a superplastic aluminum alloy and a process of producing the same.

2. Description of the Related Art

The hot-workability of aluminum alloy has been improved by utilizing the giant elongation and low resistance to deformation in the superplastic state.

However, in the conventional art, superplasticity can be only utilized in a thin sheet having a uniform deformation because superplasticity is only manifest at certain temperatures and at certain strain rates.

If superplasticity can be manifested over a wide range of temperatures and strain rates, superplasticity can be utilized for extrusion and forging processes in which temperatures and strain rates are different between portions subject to deformation.

To manifest superplasticity in wide ranges of temperature and strain rate, it is important to control the change in microstructure, particularly the growth of crystal grains. To this end, it is necessary that the aluminum alloy contains large amount of fine particles which pin the grain boundary migration.

Metal particles and ceramic particles have been used as particles effectively pinning the grain boundaries.

To introduce metal particles in an aluminum alloy, precipitation in a solid phase and crystallization from a liquid phase are possible. In the precipitation, a large amount of metal elements must be in solid solution to precipitate a large amount of metal particles sufficient to suppress crystal grain growth. In usual ingot process, the solid soluble amount is limited, so that metal elements cannot be brought into solid solution in an amount sufficient to precipitate a large amount of particles necessary to effect pinning of gain boundaries. Japanese Unexamined Patent Publication (Kokai) No. 3-28344 proposed a method of forcibly making a solid solution by powder metallurgy. However, powder metallurgy has a problem in that the production cost is high and the material shape is also limited.

On the other hand, in the crystallization, it is important that particles are finely and uniformly crystallized from a melt. To this end, Japanese Unexamined Patent Publication (Kokai) No. 8-74012 proposed a method of reacting an aluminum melt with a ceramic powder to form metal particles. However, this method requires a long time for the reaction and the reaction is difficult to control.

To introduce ceramic particles into an aluminum alloy, the following two methods are proposed. In the first method disclosed in Japanese Unexamined Patent Publication (Kokai) No. 8-74012, metal elements in an aluminum melt are reacted with a blown-in gas to form ceramic particles. However, as described above, this method requires a long time for the reaction and the reaction is difficult to control. The second method is to add ceramic particles to an aluminum melt. However, this method has a problem that it is generally difficult to uniformly disperse ceramic particles in an aluminum alloy melt. Japanese Unexamined Patent Publication (Kokai) No. 6-235032 proposed a method in which a ceramic powder is uniformly mixed with an aluminum alloy powder and is then press-formed. However, this method not only causes an increase in the production cost but also limits the material shape. Moreover, this method uses coarse TiC particles having a particle size up to 45 μm, which increases the dispersion strengthening effect when present in a large amount, so that the high temperature strength is increased to render the thermomechanical treatment difficult and the room temperature strength is also increased as well as the elongation is reduced to render the secondary operation after superplastic deformation difficult. Therefore, particles cannot be introduced in an amount effective for grain boundary pinning.

### SUMMARY OF THE INVENTION

The object of the present invention is to provide a superplastic aluminum alloy in which the above-mentioned conventional problems are solved by dispersing fine particles having no substantial dispersion strengthening effect in an amount sufficient to effect grain boundary pinning to suppress grain growth during hot working, thereby enabling manifestation of superplasticity in a wide range of temperatures and strain rates.

To achieve the object according to the present invention, there is provided a superplastic aluminum alloy containing ceramic particles having an average particle size of from 10 nm to 500 nm in an amount of from 0.1 vol % to 5 vol %.

In the present invention, the term “superplasticity” means that an elongation of 200% or more is obtained in a high temperature tensile test at a hot working temperature or a temperature of Tm/2 or higher, Tm being a melting point expressed in terms of absolute temperature.

The aluminum alloy of the present invention is an alloy composed of a matrix containing a dispersion of ceramic particles. The matrix may be composed either of aluminum alone or an aluminum alloy containing Si, Cu, Mn, Mg, Cr, Zn or other elements which are usual alloying elements of aluminum alloys. The alloy may further contain one or more of REM, Zr, V, W, Ti, Ni, Nb, Ca, Co, Mo, and Ta which form globular particles of intermetallic compounds with aluminum during homogenization treatment. These elements may be contained in an amount at which no giant crystallized particles are formed. However, these elements are preferably contained in a small amount when ceramic particles are present in a large amount which renders thermomechanical treatment or secondary operation difficult. Intermetallic compounds preferably have a particle size of 500 nm or less, the same as for ceramic particles.

Fe or other impurities usually present in aluminum alloys are acceptable if they are present in an amount within the range in which no giant crystallized particles are formed.

Ceramic particles may be acceptable if they do not react with the matrix aluminum and alloying elements and if stable during hot working and may be carbides, nitrides, carbonitrides, borides, silicides, oxides, and so on. The aluminum alloy of the present invention may contain particles of one or more ceramics. Ceramic particles may be introduced in an aluminum alloy by any method, such as in-situ processes in an aluminum melt, vapor phase processes, solid phase processes, firing of metal complexes, and so on, although in-situ processes are most preferably because of good wettability with aluminum melt and uniform dispersion. The shape of the ceramic particles are not limited so long as a required pinning is achieved while dispersion strengthening is avoided, although a spherical shape is most preferred from a viewpoint of formability.

Grain boundary pinning is not achieved if the ceramic particles have too small or large a size. To ensure grain boundary pinning, ceramic particles must have an average size of from 10 nm to 500 nm.

When the average particle size is less than 10 nm, grain boundary pinning is not achieved because dislocation cells are difficult to form because the dislocations introduced during hot working form loops, etc. When the average particle size is more than 500 nm, dislocation cells are difficult to form and grain boundary pinning is not achieved. Average particle size of more then 500 nm are also disadvantageous because dispersion strengthening is significant to increase the high temperature strength failing to provide superplasticity and also to increase the room temperature strength and reduce the elongation to render the secondary operation difficult. It should be noted that when the average particle size is more than 300 nm, grain boundary pinning is not significantly increased. Therefore, to ensure grain boundary pinning while avoiding dispersion strengthening, the average particle size is not preferably more than 300 nm.

The content of ceramic particles must be 0.1 vol % or more but must not be more than 5 vol % to avoid dispersion strengthening. It should be noted that if the content is more than 1 vol %, grain boundary pinning is not significantly increased. Therefore, to ensure grain boundary pinning while avoiding dispersion strengthening, the content of ceramic particles is not preferably more than 1 vol %.

The ceramic particles are preferably dispersed at an average interparticle distance of not more than 50 μm to promote grain refinement.

In a preferred embodiment, an aluminum alloy according to the present invention contains Mg in an amount of 4 wt % or more. Mg is a main element for strengthening through a strengthening mechanism in which resistance to transgranular deformation is increased by solid solution strengthening and a decrease in cross slip due to reduction in stacking fault energy. This decreases the grain boundary strength with respect to the grain strength at high temperatures to promote grain boundary migration and grain boundary slip, thereby facilitating manifestation of superplasticity. This effect is significant when the Mg content is 4 wt % or more. The upper limit of the Mg content is not necessarily specified but when the content exceeds 15 wt %, the hot workability is too low to be practically acceptable. Cu, Zn or elements having grain strengthening effect because of reduction in stacking fault energy are also utilized to promote superplasticity in the same mechanism as for Mg.

Aluminum alloys containing Mg as a main alloying element are also advantageous because the room temperature elongation is large to facilitate secondary operation after superplastic deformation and because both elongation and strength are high to provide good toughness. Conventionally, aluminum alloys containing Mg in an amount of 2 wt % or more had poor hot workability and were difficult to extrude or forge. According to the present invention, it is possible to perform hot superplastic forming of high strength, high toughness aluminum alloys containing Mg in an amount of 4 wt % or more.

A process of producing a superplastic aluminum alloy according to the present invention comprises the steps of: hot working an aluminum alloy ingot containing ceramic particles having an average particle size of from 10 nm to 500 nm in an amount of from 0.1 vol % to 5 vol % with a working degree of from 10% to 40% at a temperature of 400° C. or higher; heat-treating at a temperature of 400° C. or higher; and hot-working with a working degree of 40% or more at a temperature of lower than 400° C.

The first hot working destroys a cast structure. If the cast structure remains, the second hot working cannot form a uniform fine structure of dislocation cells necessary to provide grain boundary pinning. The first hot working is performed at a temperature of 400° C. or higher to avoid precipitation of solute atoms and impurities. However, the temperature must not be higher than the solidus line to prevent formation of a liquid phase. Temperatures of from 400° C. to 500° C. are generally suitable.

To destroy the cast structure, the working degree must be at least 10%. The upper limit of the working degree is 40%, because the effect does not increase at greater working degrees.

The first hot working provides a nonuniform worked structure (dislocation structure) which, if it remained unchanged, would cause a nonuniform dislocation cell structure to be formed by the second hot working and the desired fine grained structure would not be achieved. Therefore, a heat treatment is performed after the first hot working to extinguish the nonuniform worked structure.

Heat treatment temperatures of lower than 400° C. require a long treatment time and are not practically acceptable. On the other hand, the heat treatment temperature must not be higher than the solidus line to prevent formation of a liquid phase. Temperatures of from 400° C. to 500° C. are generally suitable. The heat treatment time is suitably from 1 to 4 hours.

The heat treatment may either be performed immediately after the first hot working without cooling or may be performed by reheating after cooling to the ambient or room temperature.

The second hot working introduces dislocations entangled with uniformly distributed particles to form equiaxed dislocation cells, thereby providing an equiaxed fine grained structure to manifest superplasticity.

If the second hot working is performed at a temperature of 400° C. or higher, recovery of dislocation occurs during the working and the desired fine grained structure is not achieved. The lower limit of the temperature is selected to prevent cracking from occurring during the working. Temperatures of from 200° C. to 300° C. are generally suitable.

To provide a fine grained structure necessary to manifest superplasticity, the working degree must be at least 40%.

The second hot working may either be performed subsequent to the heat treatment after cooling to a temperature of lower than 400° C. or may be performed by reheating after cooling to the ambient or room temperature.

### BRIEF DESCRIPTION OF THE DRAWINGS

FIG. 1 is a graph showing the elongation observed in temperature tensile test of a superplastic aluminum alloy according to the present invention as a function of the testing temperature and the strain rate;

FIG. 2 is a graph showing the elongation observed in high temperature tensile test of a conventional superplastic aluminum alloy as a function of the testing temperature and the strain rate; and

FIGS. 3(1) and 3(2) are microphotographs of (1) an aluminum alloy according to the present invention and (2) a conventional aluminum alloy after high temperature tensile test.

### DESCRIPTION OF THE PREFERRED EMBODIMENT

The present invention will be described in further details by way of examples below.

### Example 1

Aluminum alloy ingots having different chemical compositions summarized in Table 1 were homogenization heat-treated at 440° C. for 24 hours.

The ingots were then swaged, as the first hot working, at 400° C. with a working degree of 10%, and immediately thereafter, heat-treated at 400° C. for 1 hour followed by water cooling. The second hot working was then performed by hot swaging at 300° C. with a working degree of 50%, followed by water cooling.

Test pieces having a 5 mm dia., 10 mm long gauge portion were cut from the thus-produced samples and subjected to tensile test at temperatures of from 300° C. to 500° C., strain rates of from 1.7×10⁻⁴/s to 1.7×10⁻¹/s. The results are summarized in Table 1.

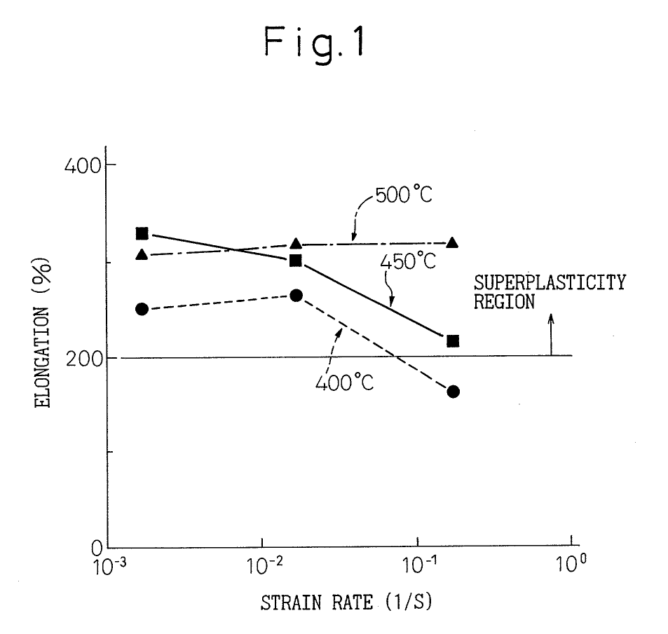

Sample No. 1 according to the present invention contained 0.2 vol % of TiC particles having an average diameter of 200 nm, which were produced through in-situ process by reacting stoichiometric proportions of Ti and C in a pure aluminum melt. Superplasticity (elongation of 200% or more) was observed over wide ranges of working temperatures and strain rates as can be seen from FIG. 1.

Comparative sample No. 2 containing no particles did not exhibit superplasticity.

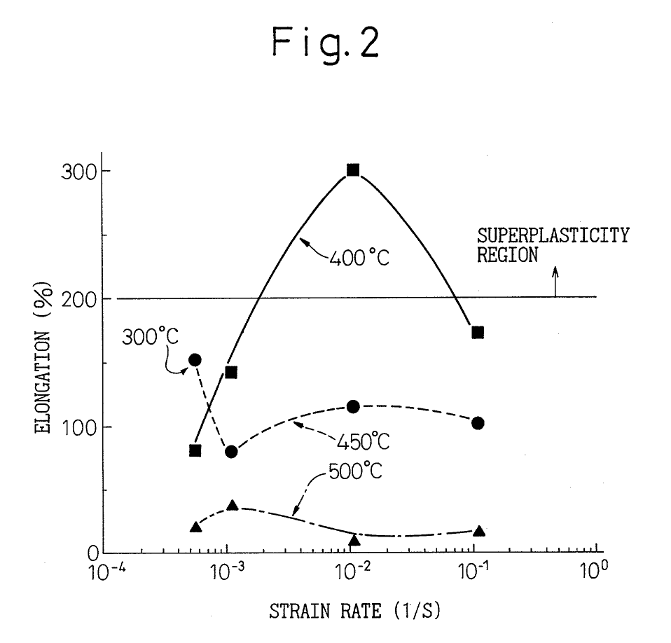

Comparative samples No. 3 and No. 4 were conventional superplastic aluminum alloys and contained dispersion strengthening particles of Al₃Zr, which is not a ceramic but an intermetallic compound, so that superplasticity was manifested in narrower ranges of working temperature and strain rate. This is shown in FIG. 2 for sample No. 4.

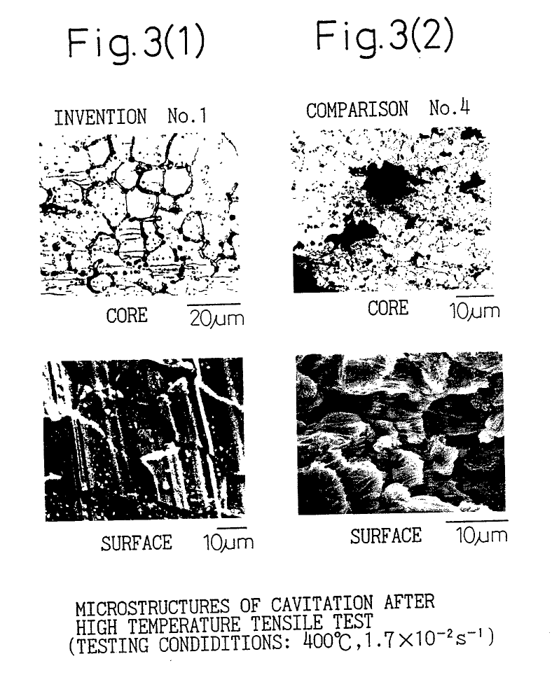

After the high temperature tensile test, the test pieces were subjected to optical microscopic observation for the internal structure and scanning electron microscopic observation for the surface structure. FIGS. 3(1) and 3(2) show typical examples.

Sample No. 1 containing dispersed ceramic particles having a size and a content according to the present invention and exhibiting a superplasticity of up to 300% contained extremely small amount of cavitation or voids as shown in FIG. 3(1), which ensures good room temperature strength and secondary operability.

Comparative sample No. 4 containing dispersed intermetallic compound particles contained large amount of cavitation as shown in FIG. 3(2), which causes significant degradation of room temperature strength and secondary operability even if the sample was deformed to one half of the superplastic elongation.

### Example 2

Aluminum alloy ingots having different chemical compositions summarized in Table 2 were thermomechanically treated as in Example 1.

Sample No. 5 according to the present invention contained in-situ produced TiC particles having an average particle size of 200 nm in an amount of 0.7 vol % as in Sample 1 of Example 1. Comparative Samples 6 to 8 have the same chemical compositions as those of Comparative Samples 2 to 4 of Example 1, respectively.

From the thus-produced samples, extrusion test pieces having a diameter of 7 mm and a length of 10.5 mm were cut and subjected to extrusion test with an extrusion ratio of 14, at a temperature of 400 to 500° C., and a strain rate of 3.5×10⁻²/s to 3.5×10⁰/s. The results are summarized in Table 3. The extrudability was evaluated such that when the extrusion stress was less than that required for JIS 7003 alloy, the tested sample had a better extrudability and when a more extrusion stress was required, the tested sample had a poor extrudability.

Sample 5 of the present invention exhibited a good extrudability, i.e., required a low extrusion stress.

Comparative Sample 5 contained no dispersed particles and exhibited a very poor extrudability because of a very high extrusion stress required.

Comparative Samples 7 and 8 did not exhibit superplasticity over wide ranges of temperatures and strains rate and required high extrusion stress causing poor extrudability.

### Example 3

Aluminum alloy ingots having the same chemical composition as that of Sample 1 of Table 1 were thermomechanically treated under different conditions summarized in Table 4.

Test pieces having a 5 mm dia., 10 mm long gauge portion were cut from the thus-produced samples and subjected to tensile test at temperatures of from 300° C. to 500° C., and at strain rates of from 1.7×10⁻⁴/s to 1.7×10⁻¹/s. The results are summarized in Table 4.

Sample 9 of the present invention exhibited superplasticity over wide ranges of temperatures and strain rates.

Comparative Sample 10 was not homogenization-treated and contained undissolved giant crystallized substances, so that the second hot working failed to form uniform fine-grained structure and superplasticity was not manifested.

In Comparative Sample 11, the first hot working was performed at a small working degree and the cast structure was not completely destroyed, so that the second hot working failed to form uniform fine-grained structure and superplasticity was not manifested.

In Comparative Sample 12, the first hot working was performed at a lower temperature to form coarse acicular precipitates of impurities, so that the second hot working failed to form uniform fine-grained structure and superplasticity was not manifested.

In Comparative Sample 13, the heat treatment after the first hot working was performed at a low temperature and nonuniform worked structure retained, so that the second hot working failed to form uniform fine-grained structure and superplasticity was not manifested.

In Comparative Sample 14, the second hot working was performed at a high temperature and failed to form uniform fine-grained structure, so that superplasticity was not manifested.

In Comparative Sample 15, the second hot working was performed with a small working degree and failed to form uniform fine-grained structure, so that superplasticity was not manifested.

TABLE 1

| | | | | | | | | | Volume percentage | | |
|---|---|---|---|---|---|---|---|---|---|---|---|
| | | Chemical composition [wt %] | | | | | | | of dispersed | Manifestation of superplasticity | |
| | | Mg | Ti | C | Zr | Fe | Si | Al | particles [vol %] | Temperature [° C.] | Strain rate [S⁻¹] |
| Invention | No. 1 | 4.99 | 0.34 | 0.05 | — | 0.02 | 0.01 | Bal. | TiC:0.2 | 400-500 | 1.7 × 10⁻³ − 10⁻¹ |
| Comparison | No. 2 | 5.02 | — | — | — | 0.02 | 0.01 | Bal. | — | — | — |
| | No. 3 | 4.63 | — | — | 0.21 | 0.02 | 0.01 | Bal. | Al₃Zr:0.25 | 500 | 1.7 × 10⁻¹ |
| | No. 4 | 9.21 | — | — | 0.12 | 0.02 | 0.01 | Bal. | Al₃Zr:0.14 | 400-420 | 1.7 × 10⁻² − 10⁻¹ |

TABLE 2

| | | | | | | | | | Volume percentage |
|---|---|---|---|---|---|---|---|---|---|
| | | Chemical composition [wt %] | | | | | | | of dispersed |
| | | Mg | Ti | C | Zr | Fe | Si | Al | particles [vol %] |
| Invention | No. 5 | 4.84 | 1.21 | 0.28 | — | 0.02 | 0.01 | Bal. | TiC:0.7 |
| Comparison | No. 6 | 5.02 | — | — | — | 0.02 | 0.01 | Bal. | — |
| | No. 7 | 4.63 | — | — | 0.21 | 0.02 | 0.01 | Bal. | Al₃Zr:0.25 |
| | No. 8 | 9.21 | — | — | 0.12 | 0.02 | 0.01 | Bal. | Al₃Zr:0.14 |

TABLE 3

| Extrusion temperature | | Extrusion stress [MPa] | | | | | | | | | |
|---|---|---|---|---|---|---|---|---|---|---|---|
| [° C.] | | 400 | | | 450 | | | 500 | | | Extrud- |
| Extrusion speed [S⁻¹] | | 3.5 × 10⁻² | 3.5 × 10⁻¹ | 3.5 × 10⁰ | 3.5 × 10⁻² | 3.5 × 10⁻¹ | 3.5 × 10⁰ | 3.5 × 10⁻² | 3.5 × 10⁻¹ | 3.5 × 10⁰ | ability |
| Invention | No. 5 | 100 | 198 | 242 | 68 | 102 | 179 | 46 | 94 | 134 | Good |
| Comparison | No. 6 | 222 | 271 | 330 | 130 | 205 | 269 | 85 | 147 | 219 | Poor |
| | No. 7 | 163 | 244 | 326 | 115 | 170 | 246 | 77 | 127 | 189 | Poor |
| | No. 8 | 134 | 248 | 365 | 96 | 164 | 298 | — | — | — | Poor |
| Reference | 7003 | 93 | 148 | 202 | 75 | 113 | 151 | 54 | 76 | 109 | — |
| material | | | | | | | | | | | |

TABLE 4

| | | | | Intermediate | | High Temperature |
|---|---|---|---|---|---|---|
| | | Homogenize | 1st Hot Work | Heat Treatment | 2nd Hot Work | Elongation [%] |
| Invention | No. 9 | 440° C. × 24 hr | 400° C. × 1 hr | 400° C. × 1 hr | 300° C. × 50% | 330 |
| Comparison | No. 10 | — | 400° C. × 10% | 400° C. × 1 hr | 300° C. × 50% | 70 |
| | No. 11 | 440° C. × 24 hr | 400° C. × 5% | 400° C. × 1 hr | 300° X. × 50% | 110 |
| | No. 12 | 440° C. × 24 hr | 300° C. × 10% | 400° C. × 1 hr | 300° C. × 50% | 145 |
| | No. 13 | 440° C. × 24 hr | 400° C. × 10% | 300° C. × 1 hr | 300° C. × 50% | 160 |
| | No. 14 | 440° C. × 24 hr | 400° C. × 10% | 400° C. × 1 hr | 500° C. × 50% | 150 |
| | No. 15 | 440° C. × 24 hr | 400° C. × 10% | 400° C. 1 hr | 300° C. × 30% | 175 |

As herein described above, the present invention provides a superplastic aluminum alloy in which fine particles not substantially dispersion hardening are dispersed in a sufficient amount to effect grain boundary pinning to suppress crystal grain growth during hot working thereby ensuring manifestation of superplasticity over wide ranges of working temperatures and strain rates.

1. A superplastic aluminum alloy containing ceramic particles having an average particle size of from 10 nm to 500 nm in an amount of from 0.1 vol % to 5 vol %.

2. A superplastic aluminum alloy according to claim 1, which contains 4 wt % or more of Mg.

3. A superplastic aluminum alloy according to claim 1 or 2, wherein the ceramic particles are composed of TiC.

4. A process of producing a superplastic aluminum alloy, comprising the steps of:
hot working an aluminum alloy ingot containing ceramic particles having an average particle size of from 10 nm to 500 nm in an amount of from 0.1 vol % to 5 vol % with a working degree of from 10% to 40% at a temperature of 400° C. or higher;
heat-treating at a temperature of 400° C. or higher; and
hot-working with a working degree of 40% or more at a temperature lower than 400° C.
